(19) United States
(12) Patent Application Publication
(10) Pub. No.: US 2002/0059497 A1
(43) Pub. Date: May 16, 2002

(54) Data storage control method, data storage control apparatus, and storage medium storing data storage control program

(76) Inventor: Shinichi Komori, Kanagawa (JP)

Correspondence Address: WILLIAM S. FROMMER, Esq., c/o FROMMER LAWRENCE & HAUG LLP, 745 Fifth Avenue, New York, NY, 10151, US

(21) Appl. No.: 09/992,074

(22) Filed: Nov. 14, 2001

(30) Foreign Application Priority Data
Nov. 16, 2000 (JP) P2000-348958

(51) Int. Cl. G06F 12/00

(52) U.S. Cl. 711/111

(57) ABSTRACT

A data storage control method and a data storage control apparatus are provided which mitigate the access concentration on a particular storage unit while maintaining both high-speed operation and system redundancy. To be more specific, driver blocks installed on client machines respectively each function as a controller for dividing source data into blocks and storing these blocks in a plurality of storage units in a distributed manner. These blocks include primary data blocks for normal use and secondary data blocks which are alternatively used if the primary data have inaccessible blocks. The controller, when storing the secondary blocks into the plurality of storage units, stores last j blocks in place of first j blocks in every N blocks, N being equal to the number of storage units, and sequentially updates the value of j from 1 to N−1 for every N blocks.

### BACKGROUND OF THE INVENTION

The present invention relates generally to a data storage control method, a data storage control apparatus, and a storage medium storing a data storage control program. More particularly, the present invention relates to a data storage control method, a data storage control apparatus, and a storage medium storing a data storage control program which are suitably applicable to a data server composed of a plurality of storage units to mitigate the access concentration to particular one of these storage units and enhance the redundancy in storage configuration while preventing the scale of the server from growing.

Recently, digital networking has been making inroads into almost every sector of society, which requires the data accumulation systems (or so-called data servers) to operate faster and with enhanced redundancy.

Take broadcasting as an example. The data (such as audio and video data forming broadcast programs), which have been mostly stored in magnetic tape devices as analog data, are now stored in mass storage units such as hard disks as digital data. Although inferior, as a single unit, in storage capacity to magnetic tape devices, these mass storage units are apparently infinite in storage capacity (if the limitation of the operating system can be ignored) by use of disk array technologies such as RAID (Redundant Arrays of Independent Disks) technology. In addition, these mass storage units allow access at much faster than the magnetic tape devices and in a random manner. These features are indispensable especially for broadcasting services, which requires nonlinear editing. However, because the broadcast data are stream data, the broadcast data servers must ensure a constant level of access performance, thereby requiring a higher level of required performance than general-purpose data servers. Further, the broadcast data, which are transmitted as planned on a second basis in accordance with a program guide should never be lost. In this aspect, much higher performance in redundancy is required of the broadcast data servers than the general-purpose data servers, which can recover lost data by use of backup data.

Now, referring to FIG. 1, there is shown a schematic configuration of data servers used in broadcasting services. A data server 1 is made up of a plurality (3 in this example) of independent storage units 1a through 1c, which can be accessed from a plurality of data using devices (client machines 3a through 3d in this example) via a network 2.

The storage units 1a, 1b and 1c store broadcast data A, B, and C respectively. For example, if the client machine 3a requires broadcast data A, the client machine 3a accesses the storage unit 1a via the network 2 to read the broadcast data A. If the client machine 3a requires broadcast data B, the client machine 3a accesses the storage unit 1b via the network 2 to read the broadcast data B. If the client machine 3a requires broadcast data C, the client machine 3a accesses the storage unit 1c via the network 2 to read the broadcast data C.

A major drawback in the above-mentioned configuration is that the concentration of access operations on same data at a time causes drastic response deterioration. For example, if two or more client machines access broadcast A in the storage unit 1a, the storage unit 1a must respond to the accesses from (or transmit broadcast data A to) all the requesting client machines. However, because the response performance of the storage unit 1a is limited, the response to the two or more access operations is necessarily slowed down even to a level in which video and audio signals are disrupted to prevent the normal reproduction of the received broadcast data in the worst case.

Referring to FIG. 2, there is shown a schematic configuration of a data server which is an improvement on the configuration shown in FIG. 1. With reference to FIG. 2, components similar to those previously described with FIG. 1 are denoted by the same references. Referring to FIG. 2, a data server 4 is made up of a plurality (3 in this example) of independent storage units 4a through 4c), which is the same as that of the configuration shown in FIG. 1. However, the configuration of FIG. 2 differs from the configuration of FIG. 1 in data storage scheme. Namely, each of broadcast data A through C is divided into fixed-length blocks (hereafter simply referred to as blocks) B0, B1, B2, . . . , B32 for example, these blocks being stored over the three storage units in a manner as shown in FIG. 2. It is assumed here that blocks B0 through B10 be broadcast data A, blocks B11 through B18 be broadcast data B, and blocks B19 through B32 be broadcast data C. Then, if the client machine 3a requires the broadcast data A, the client machine 3a cyclically accesses the storage units 4a through 4c to retrieve blocks B0 through B10 in this order.

According to the data storage scheme shown in FIG. 2, access concentration on same data causes no response slowdown unless a match in cyclic period occurs (namely, multiple accesses to a same block occur). Therefore, the configuration of FIG. 2 is especially suitable for broadcast data servers. Thus, this improved data server is advantageous in avoiding the response slowdown due to access concentration, but at redundancy performance. If any of the storage units 4a through 4c fails, the data blocks stored in the failed device cannot be read.

Referring to FIG. 3, there is shown a schematic configuration of a data server obtained by solving the above-mentioned drawbacks. A data server 5 is generally the same as the data server 4 shown in FIG. 2 in that the server data 5 is composed of a plurality (3 in this example) of independent storage units 5a through 5c and the broadcast data are divided into fixed-length blocks B0, B1, B2, and so on which are cyclically stored in the storage units 5a through 5c. A difference lies in that the data server 5 stores not only the broadcast data which are used normally (primary data) but also the duplication of the primary broadcast data (the duplication referred to as secondary data). Like the primary data, the secondary data are divided into fixed-length blocks B0, B1, B2, and so on which are cyclically stored in the storage units 5a through 5c.

Let the primary data blocks stored in the storage unit 5a be “PR1,” the primary data blocks stored in the storage unit 5b be “PR2,” and the primary data blocks stored in the storage unit 5c be “PR3.” Also, let the secondary data blocks having the same contents as PR1 be “SC1,” the secondary data blocks having the same contents as PR2 be “SC2,” and the secondary data blocks having the same contents as PR3 be “SC3.” Then, SC1 is stored in the storage unit 5b, the SC2 in the storage unit 5c, and the SC3 in the storage unit 5a.

This denotes that the copy data (SC1) of the data stored (PR1) in the storage unit 5a are stored in the adjacent storage unit 5b, the copy data (SC2) of the data stored (PR2) in the storage unit 5b are stored in the adjacent storage unit 5c, and the copy data (SC3) of the data (PR3) stored in the storage unit 5c are stored in the first storage unit 5a.

According to this configuration, if the storage unit 5a fails to access to the PR1 for example, the SC1, the duplication of the PR1 is available to provide redundancy in configuration, thereby preventing a broadcasting failure for example from taking place.

However, the techniques described above, which are advantageous in configuration redundancy, still involve a problem that access operations are prone to concentrate on a particular storage unit (from which copy data are read) when a failure occurs.

For example, referring to FIG. 4, if the storage unit 5a fails, SC1 of the storage unit 5b is used for PR1 of the storage unit 5a, consequently reading B0, B3, B6, and B9 from the storage unit 5b. In addition, from the storage unit 5b, B1, B4, B7, and B10 of PR2 are also read, thereby approximately doubling the access concentration on the storage unit 5b.

### SUMMARY OF THE INVENTION

It is therefore an object of the present invention to provide a data storage control method and apparatus which mitigates the access concentration on a particular storage unit at the time of failure while ensuring both high access speed and high configuration redundancy.

In carrying out the invention and according to one aspect thereof, there is provided a data storage control method for dividing source data into a plurality of blocks and storing the plurality of blocks into a plurality of storage units respectively, the plurality of blocks being composed of a primary data block for normal use and a secondary data block which is read in substitution for the primary data block if the same becomes inaccessible. The data storage control method includes the steps of: when storing the secondary blocks into the plurality of storage units, storing last J blocks in place of first J blocks in every N blocks (N is equal to the number of storage units) and updating a value of the J sequentially from 1 to N−1 for every N blocks.

Consequently, the correlation between the primary data block array and the secondary data block array stored in a plurality of storage units is lost, thereby mitigating the access concentration to a particular one of the storage units when reading alternative secondary data blocks instead of inaccessible primary data blocks.

### BRIEF DESCRIPTION OF THE DRAWINGS

These and other objects of the invention will be seen by reference to the description, taken in connection with the accompanying drawing, in which:

FIG. 1 is a schematic diagram illustrating an exemplary configuration of a data server for use in broadcasting services;

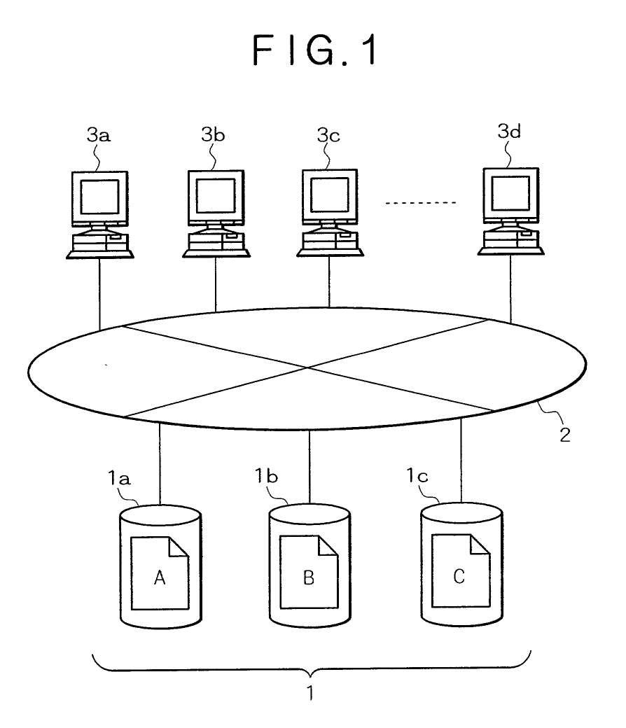

FIG. 2 is a schematic diagram illustrating an exemplary configuration of an improved data server;

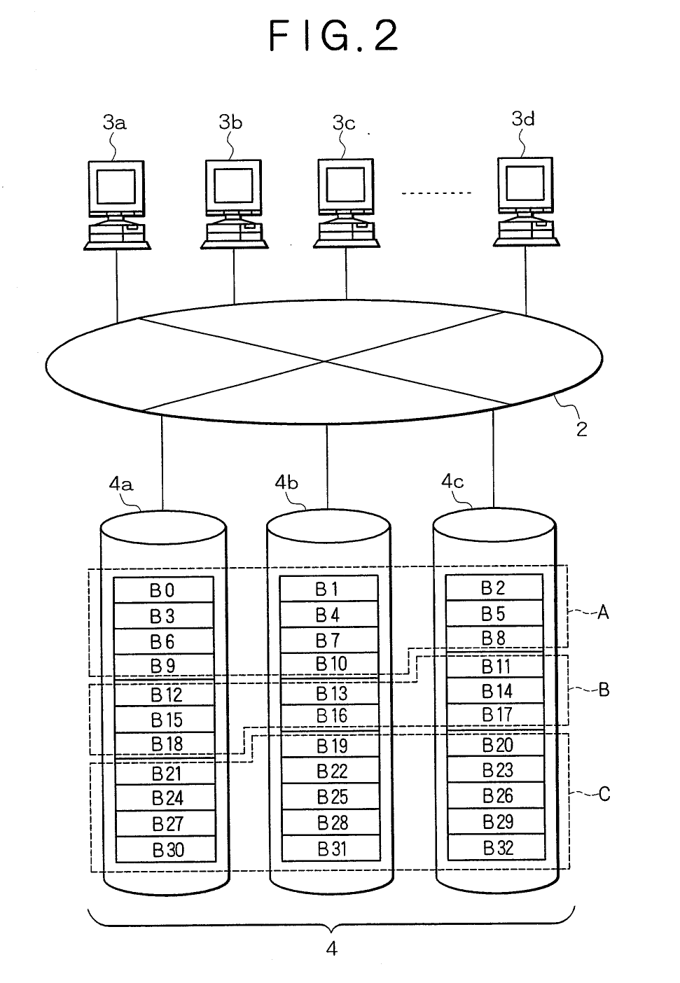

FIG. 3 is a schematic diagram illustrating a related art;

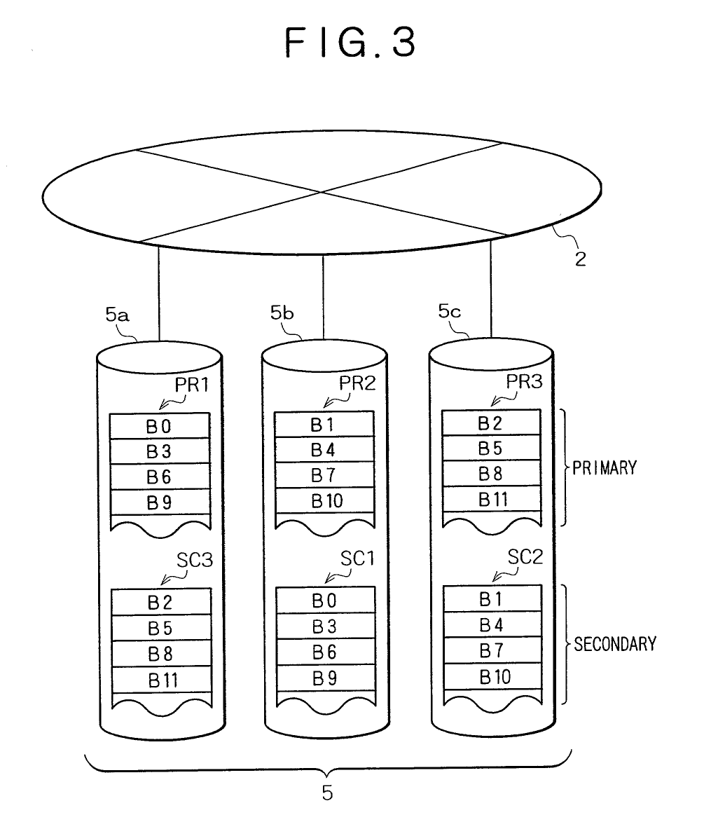

FIG. 4 is a schematic diagram illustrating drawbacks of related art;

FIG. 5 is a schematic diagram illustrating an exemplary configuration of a system practiced as one preferred embodiment of the invention;

FIGS. 6A, 6B and 6C are schematic diagrams illustrating primary and secondary block arrays when N=4;

FIG. 7 is a schematic diagram illustrating specific secondary data when N=4;

FIG. 8 is an exemplary map of sequence of numbers;

FIG. 9 is a diagram representing the secondary block shown in FIG. 3 in planar coordinates of column and row;

FIG. 10 is a flowchart describing an exemplary algorithm for generating a map of sequence of numbers; and

FIGS. 11A, 11B, 11C, 11D, 11E, is schematic diagram illustrating a data reading operation to be executed when one (hatched) of four storage units (NS0 through NS3) fails.

### DETAILED DESCRIPTION OF PREFERRED EMBODIMENTS

This invention will be described in further detail by way of example with reference to the accompanying drawings.

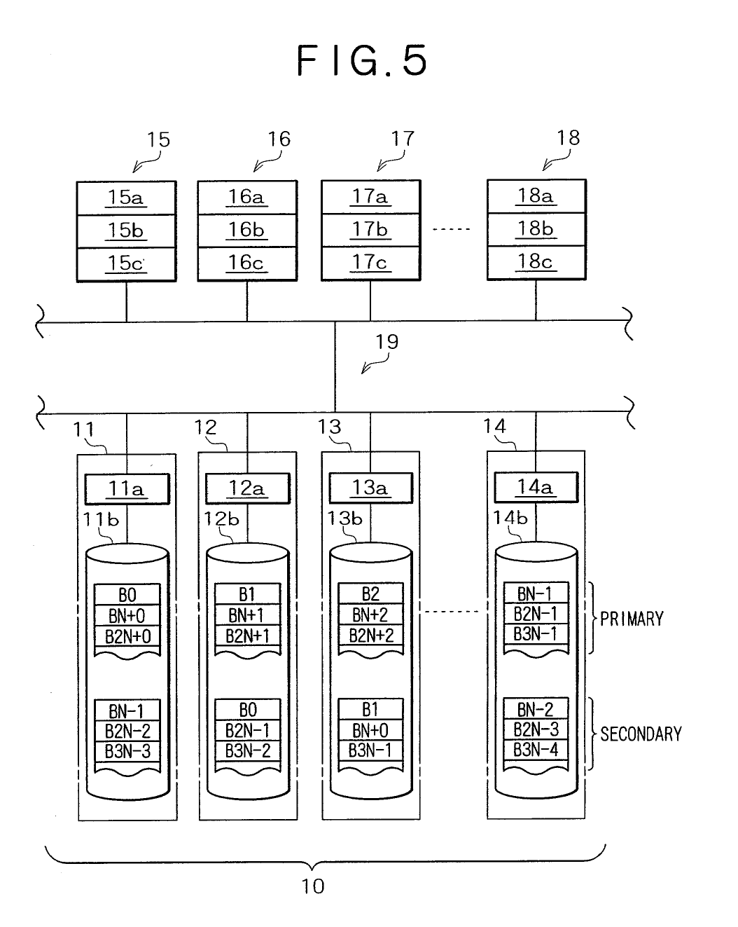

Now, referring to FIG. 5, there is shown a system practiced as one embodiment of the invention comprising a data server 10, a network 19, and client machines (devices which use provided data) 15 through 18. Data server:

The data server 10 provides N storage units (or simply storages) 11 through 14 (hereafter also referred to the first storage unit 11 through the fourth storage unit 14, given N=4). The N storage units 11 through 14 may be independent of each other in terms of space or housed in a common unit. Essentially, any storage units may do if they can be recognized as N independent storage elements in the system. For example, the N storage units may be N server computers each incorporating a mass storage unit such as a hard disk or N mass storage units incorporated in one server computer. In the former, each of the N server computer provides a storage unit. In the latter, each of the N mass storage units provides a storage unit. The capacity of each of these storage units may be any that can be recognized by the FS (File System) of the operating system under which each storage device operates. For example, the capacity may be a logical capacity defined by a disk array technology such as RAID.

The first storage unit 11 through fourth storage unit 14 preferably have a common architectural configuration. Take the first storage unit 11 as an example. The first storage unit 11 has a data input/output block 11a and a mass storage device 11b such as a hard disk. The first storage unit 11 stores a fixed-length data block (hereafter simply referred to as a data block) B* (* denotes a block number 0 or higher) inputted through the data input/output control block 11a into the mass storage device 11b and outputs the requested block data B* from the mass storage device 11b through the data input/output control block 11a.

The data block B* is of two types; a data block constituting the primary data for normal use and a data block constituting the secondary data which are redundant data. The data block B* constituting the secondary data is used in substitution for the primary data block B* having the same number as the secondary data block B* if the primary data block B* cannot be read for some reason or other. The array order of the secondary data blocks B* plays an important role in the present embodiment, which will be described later.

Client Machine:

All or part of the client machines 15 through 18 shown in FIG. 5 can generate data files or captures data files from the outside of the system. In addition, the client machines store a data file concerned into the data server 10 as primary data on a block B* basis and the data obtained by duplicating the primary data into the data server 10 as secondary data on a data block B* basis. Further, the client machines can read the desired primary data on a data block B* basis and, if the desired data block B* in the desired primary data is inaccessible, read the data block B* having the same number as the primary data in the secondary data.

The client machines 15 through 18 schematically have application blocks 15a through 18a, driver blocks 15b through 18b, and interface blocks 15c through 18c respectively. The application blocks 15a through 18a use and generate data files. The driver blocks 15b through 18b generate secondary data, divide primary and secondary data into blocks, and allocate the data blocks to the storage devices in response to requests from the application blocks 15a through 18a. The interface blocks 15c through 18c interface the input/output of signals transferred with the network 19.

The client machines 15 through 18, having the above-mentioned elements (the application blocks 15a through 18a, the driver blocks 15b through 18b, and the interface blocks 15c through 18c), may be implemented by a personal computer which operates on a general-purpose operating system such as Windows NT (trademark of Microsoft Corporation), Windows 2000 (trademark of Microsoft Corporation), or UNIX. Namely, the application blocks 15a through 18a operate on a personal computer concerned. For example, the application blocks 15a through 18a provide a broadcast program editing tool, a broadcast program management tool, and a broadcast program transmission management tool (if the illustrated system is used as a broadcast program data server system). For the interface blocks 15c through 18c, a physical element such as a network board installed on the personal computer concerned can be used. The driver blocks 15b through 18b may only have the capabilities characteristic to the present embodiment (the capabilities of generating secondary data, blocking the primary and secondary data, and allocating the storage devices in response to requests from the application blocks 15a through 18a).

Network:

The network 19 connects the client machines 15 through 18 with the data server 10 to transfer data in accordance with a predetermined communication protocol. For example, if each of the client machines 15 through 18 is a personal computer for general purpose and each of the N storage units 11 through 14 constituting the data server 10 is an individual server computer, then the network 19 may be a physical network such as Ethernet or ATM (Asynchronous Transfer Mode). If the client machines 15 through 18 and the data server 10 are accommodated in one housing, the network 19 may be a physical network such as IDE (Integrated Drive Electronics) or SCSI (Small Computer System Interface). If each of the client machines 15 through 18 and the data server 10 or each of the N storage units 11 through 15 constituting the data server 10 is distributed on different floors, buildings, or areas in a distributed manner, the network 19 may include a wide area network such the Internet.

Data File Structure in Data Server:

As described above, the data server 10 in the present embodiment internally stores the data file for normal use (the primary data) and its copy data file (the secondary data). These two types of data files are each divided into fixed-length data blocks (blocks B*) to be stored in a distributed manner. The generation of the secondary dada and the arrangement and reading of the data blocks B* are controlled by, but not exclusively, the driver block 15b of the client machines 15 through 18 which generates or uses these data files. First, the following describes the basic concept of the arrangement and reading control.

Referring to FIG. 5, the primary data and secondary data stored in the N mass storage devices 11b through 14b in the data server 10 are constituted by many schematically represented rectangular blocks, each block being attached with a block number affixed with B. Conventionally, the illustrated block numbers have a format of B*, which is 0, 1, 2, . . . , N−1, N+0, N+1, N+2, . . . , 2N−1, 2N+0, 2N+1, 2N+2, . . . , 3N−1, and so on. N represents the number of the mass storage devices 11b through 14b. For example, given N=4, then illustrated B* is B0, B1, B2, B3, B4, B5, B6, B7, B8, B9, B10, B11, and so on. The alignment of the data blocks is the order of the block numbers (in the ascending order). Take a data file as an example which is constituted by data blocks B0 through B15, the last block number being 15. Then, B0 of the primary data is stored in the first storage unit 11, B1 in the second storage unit 12, B2 in the third storage unit 13, and B3 (BN−1) in the fourth storage unit 14. These storage operations cyclically repeat up to B15 (B4N−1).

On the other hand, the secondary data differ from the primary data in that the sequences of some data blocks are replaced for storage unlike the simple ascending order storage operations as with the primary data. Namely, as shown, B0 of the secondary data is stored in the second storage unit 12, B1 in the third storage unit 13, B2(BN−2) in the fourth storage unit 14, but B3(BN−1) in the first storage unit 11. B4(BN+0) is stored in the third storage unit 13 and B5(B2N−3) in the fourth storage unit 13, but B6(B2N−2) in the first storage unit 11 and B7(B2N−1) in the second storage unit 12. B8(B3N−4) is stored in the fourth storage unit 14, B9(B3N−3) in the first storage unit 11, B10 (B3N−2) in the second storage unit 12, and B11 (B3N−1) in the third storage unit 13. Thus, the storage sequence of the secondary data in the present embodiment differ from that of the primary data in that every N secondary data blocks are stored in each storage unit with its first secondary block shifted by one behind the first secondary block of each other preceding N secondary blocks. The algorithm used in this shifting will be described later. In effect, every N secondary blocks, last j secondary blocks are replaced by first j secondary blocks for storage and the value of this j is sequentially updated up to 1 to N−1.

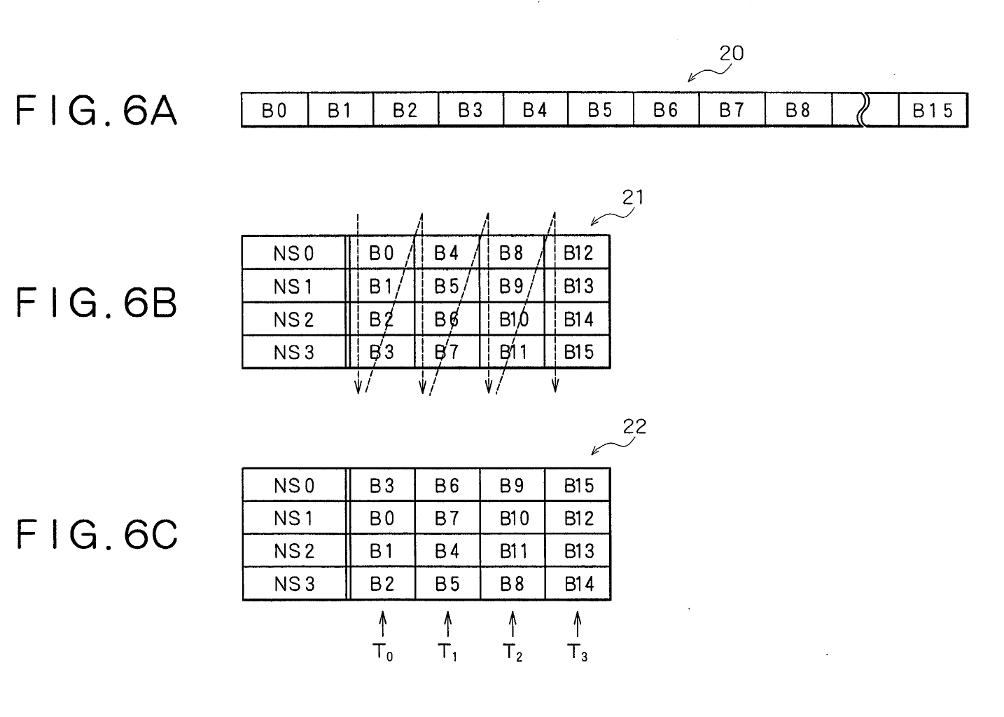

For example, FIGS. 6A, 6B and 6C schematically illustrate the block arrays of the primary and second data when N=4. In FIG. 6A, source data are represented by 16 blocks of B0 through B15 FIG. 6B illustrates the block array of the primary data. FIG. 6C illustrates the block array of the secondary data. In FIGS. 6B and 6C, the first storage unit 11 is represented by NS0, the second storage unit 12 in NS1, the third storage unit 13 in NS2, and the fourth storage unit 14 in NS3.

As shown in FIG. 6B, the primary data are stored in the ascending order of block numbers. Namely, the sequence is B0, B1, B2, B3, B4, . . . , B15 as indicated with dashed lines. The storage sequence simply and periodically repeats “NS0 to NS1 to NS2 to NS3” for every N blocks. However, as shown in FIG. 6C, with the secondary data, first cycle period TO is “NS1 to NS2, to NS3 to NS0,” second cycle period T1 is “NS2 to NS3 to NS0 to NS1,” third cycle period T2 is “NS3 to NS0 to NS1 to NS2,” and fourth cyclic period T3 is “NS1 to NS2 to NS3 to NS0.” Thus, the storage sequences are inconsecutive.

Fourth cyclic period T3 “NS1 to NS2 to NS3 to NS0” is the same as first cyclic period TO “NS1 to NS2 to NS3 to NS0,” so that, if N=4, there is a periodicity [(N−1)×N] blocks in which (NS1 to NS2 to NS3 to NS0,” “NS2 to NS3 to NS0 to NS1,” and “NS3 to NS0 to NS1 to NS2” are repeated as one set. The periodicity is constant regardless of the number of blocks of the source data.

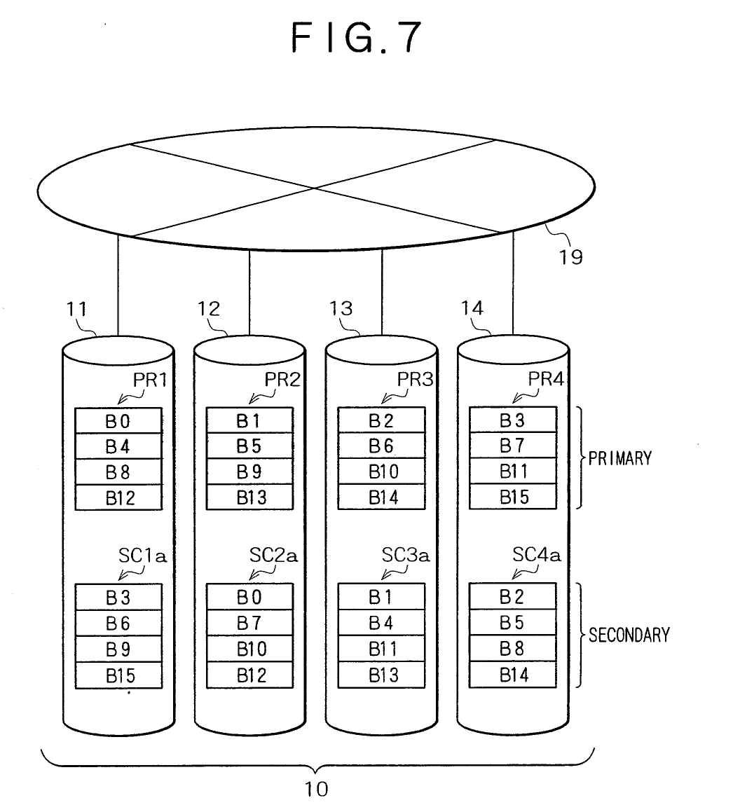

Referring to FIG. 7, there is shown a schematic diagram illustrating a specific array of the secondary data blocks constituted by use of the above-mentioned concept when N=4. Secondary data block group SC1a stored in the first storage unit 11 includes B3, B6, B9, and B15, secondary data block group SC2a stored in the second storage unit 12 consists of B0, B7, B10, and B12, secondary data block group SC3a stored in the storage unit 13 consists of B1, B4, B11, and B13, and secondary data block group SC4a stored in the fourth storage unit 14 consists of B2, B5, B8, and B14.

If all storage units 11 through 14 are operating normally, when any of the data files is requested via the network 19, blocks B* are sequentially read from the primary data block groups PR1 through PR4 stored in the storage units 11 through 14. If, for example, the first storage unit 11 fails, the data blocks having the same numbers as those of the inaccessible blocks B* are read from the secondary data block groups SC2a, SC3a, and SC4a stored in the other storage units 12 through 14 respectively.

Namely, in this case, instead of B0, B4, B8, and B12 of PR1, B0 of SC2a, B4 of SC3a, B8 of SC4a, and B12 of SC2a are read. The most advantageous point of this alternative reading lies not in the reading from one same storage unit but the reading from the storage units 12 through 14 storing SC2a, SC3a, and SC4a respectively in a distributed manner. This distributed reading mitigates the access concentration on a particular storage unit, thereby achieving one object of the present invention. Control of secondary data periodicity:

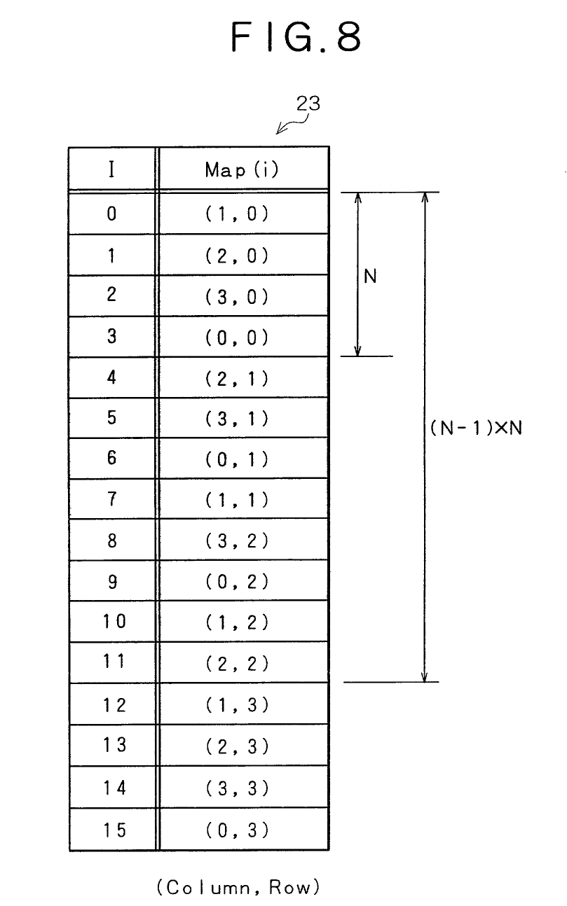

As described above, the control of secondary data periodicity is indispensable for practicing the alternative reading which includes an especially advantageous point for the present invention. As described above, the secondary data periodicity is obtained, given N=4, by providing a [(N−1)×N] block periodicity by repeating “NS1 to NS2 to NS3 to NS0,” “NS2 to NS3 to NS0 to NS1,” and “NS3 to NS0 to NS1 to NS2” as a set. To implement this periodicity, a numbers sequence map may be created as shown in FIG. 8 if N=4.

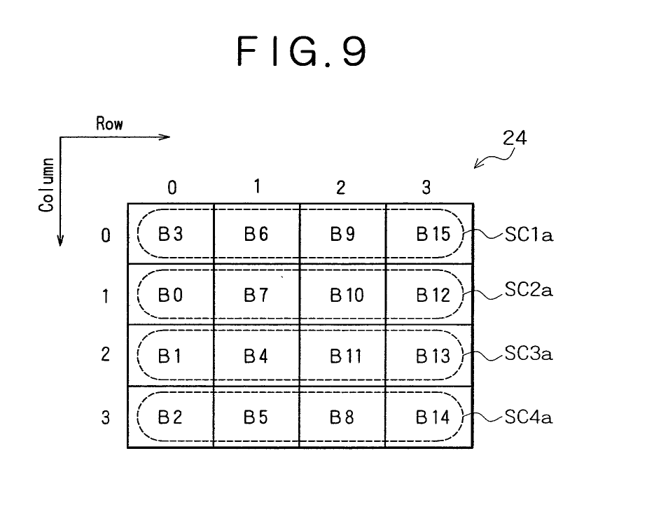

Referring to FIG. 8, “i” denotes block numbers and Map(i) denotes the storage address of each block. The storage address has a format of (column, row), where “column” denotes one of the first storage unit 11 through the fourth storage unit 14 and “row” denotes the N block unit of the data block group SC1a through SC4a in the storage units. FIG. 9 illustrates a plane coordinates representation of column and row of the secondary blocks shown in FIG. 7. In this example, column and row have each values 0 through 3. The blocks in Map(i) of FIG. 8 and the blocks in FIG. 9 correspond one to one. Therefore, block Bi of the secondary data may be stored in the data server 10 by retrieving the storage address corresponding to the block number i from the Map(i) of FIG. 8 and storing the block Bi at the retrieved storage address. When reading the block Bi of the secondary data from the data server 10, the storage address corresponding to the block number i may be retrieved from Map(i) of FIG. 8 and the block Bi may be read from that storage address.

Specific Method of Generating Number Sequence Map:

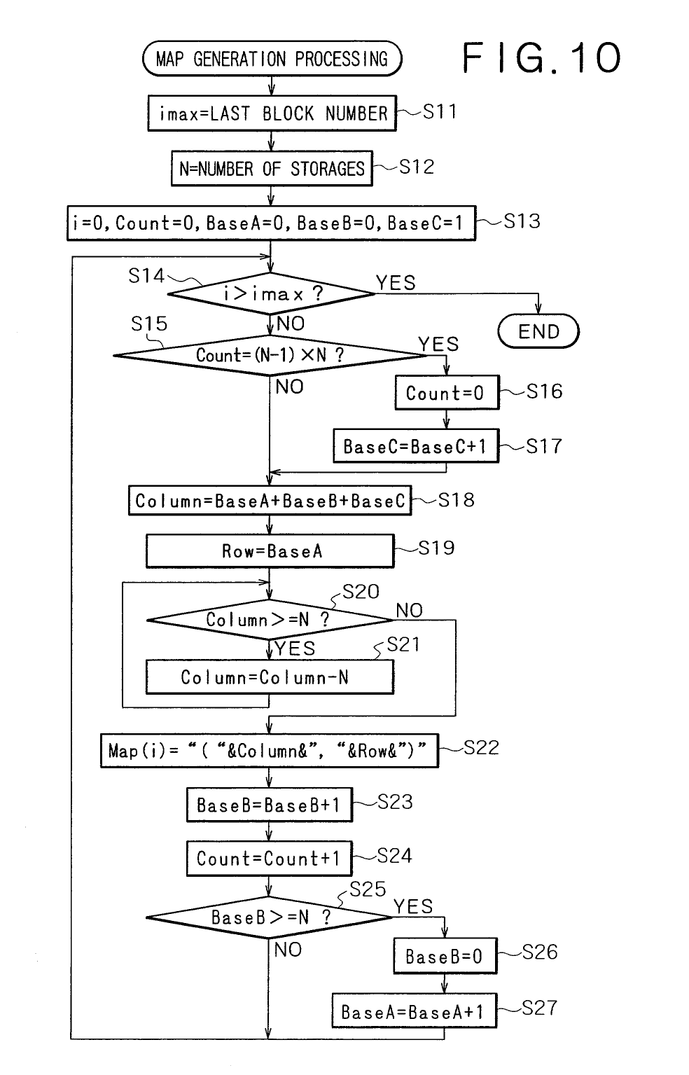

Referring to FIG. 10, there is shown a flowchart describing an algorithm for generating the above-mentioned number sequence map. It should be noted that this algorithm proves that the generation of the above-mentioned number sequence map can be implemented by a program procedure and does not prove the practicability of the algorithm.

First, various variables for use in the program shown in FIG. 10 will be described. “imax” denotes a variable for storing the last block number of the secondary data. “N” denotes a variable for storing the number of storage units (namely, the storage units 11 through 14). “i” denotes a variable for storing a block number. “Count” denotes a counter variable. “BaseA,” “BaseB,” and “BaseC” are variables for temporarily storing column and row values. “Map(i)” is a storage address storing array.

When this program is executed, first the last block number (15 in the example shown in FIG. 8) is set to “imax” (step S11) and the number of storage units (4 in the example shown in FIG. 8) is set to N (step S12). Then, “i,” “Count,” “BaseA,” “BaseB,” and “BaseC” are set to their respective initial values (i=0, Count=0, BaseA=0, BaseB=0, and BaseC=0) (step S13). The subsequent processing is repeated until “i” exceeds “imax” (the decision becomes YES in step S14).

In step S15, the program determines whether Count is [(N−1)×N] or not. Namely, by checking the periodicity [(N−1)×N] shown in FIG. 8, “Count” is initialized (to 0) every [(N−1)×N] and “BaseB” is incremented by 1 (steps S16 and S17).

In steps S18 and S19, BaseA, BaseB, and BaseC are added to set a result to Column and BaseA is set to Row.

In steps S20 and S21, if the value of Column is N (=4) or higher, equation “Column=Column−N” is repetitively computed until this value becomes below N. For example, if the value of Column is equal to or higher than N and below 2N, the equation is executed once; if the value is equal to or higher than 2N and below 3N, the equation is executed twice; if the value is equal to or higher than mN (m+1), the equation is executed m times (m is 3 or higher integer).

In step S22, the i-th array element of Map(i) is generated by use of Column and Row. In the step shown, in order to conventionally make a match with the format (Column, Row) of Map(i) shown in FIG. 8, the right term of the equation is enclosed by parentheses “(“and ”)” and Column and Row are separated by a comma “,”. However, the format is not necessarily limited thereto.

In steps S23 through S27, BaseB and Count are incremented by 1. If Base B is equal to or higher than N, BaseB is initialized (=0) and BaseA is incremented by 1.

The following describes an actual operation of the above-mentioned program by substituting actual values into i for increment.

i=0:

When i=0, BaseA=0, BaseB=0, and BaseC=1. Therefore, in steps S18 and S19, Column=1 and Row=0, so that an array of Map(0) of “(1, 0)” is generated in step S22 and then BaseB and Count are incremented by 1 in steps S23 and S24 respectively.

i=1:

When i=1, BaseA=0, BaseB=1, and BaseC=1. Therefore, in steps S18 and S19, Column=2 and Row=0, so that an array of Map(1) of “(2, 0)” is generated in step S22 and then BaseB and Count are incremented by 1 in steps S23 and S24 respectively.

i=2:

When i=2, BaseA=0, BaseB=2, and BaseC=1. Therefore, in steps S18 and S19, Column=3 and Row=0, so that an array of Map(2) of “(3, 0)” is generated in step S22 and then BaseB and Count are incremented by 1 in step S23 and S24 respectively.

i=3:

When i=3, BaseA=0, BaseB=3, and BaseC=1. Therefore, in steps S18 and S19, Column=4 and Row=0. However, because Column=4 is equal to N (=4), “Column=Column−N” is computed in step S21 to correct Column to “4−4=0.” Therefore, Column=0 and Row=0, so that an array of Map(3) of “(0, 0)” is generated in step S22 and BaseB and Count are incremented by 1 in steps S23 and S24 respectively. Because this increment makes BaseB equal to N (=4), BaseB is initialized (=0) and BaseA is incremented by 1 steps S26 and S27 respectively.

i=4:

When i=4, BaseA=1, BaseB=0, and BaseC=1. Therefore, in steps S18 and S19, Column=2 and Row=1, so that an array of Map(4) of “(2, 1)” is generated in step S22 and then BaseB and Count are incremented by 1 in steps 23 and 24 respectively.

i=5:

When i=5, BaseA=1, BaseB=1, and BaseC=1. Therefore, in steps 18 and 19, Column=3 and Row=1, so that an array of Map(5) of “(3, 1)” is generated in step S22 and then BaseB and Count are incremented by 1 in steps 23 and 24 respectively.

i=6:

When i=6, BaseA=1, BaseB=2, and BaseC=1. Therefore, in steps S18 and S19, Column=4 and Row=1. However, because Column=4 is equal to N (=4), “Column=Column−N” is computed in step S21 to correct Column to “4−4=0.” Therefore, Column=0 and Row=1, so that an array of Map(6) of “(0, 1)” is generated in step S22 and BaseB and Count are incremented by 1 in steps S23 and S24 respectively.

1=7:

When i=7, BaseA=1, BaseB=3, and BaseC=1. Therefore, in steps S18 and S19, Column=5 and Row=1. However, because Column=5 is higher than N (=4), “Column=Column−N” is computed in step S21 to correct Column to “5−4=1.” Therefore, Column=1 and Row=1, so that an array of Map(7) of “(1, 1)” is generated in step S22 and BaseB and Count are incremented by 1 in steps S23 and S24 respectively. Because this increment makes BaseB equal to N (=4), BaseB is initialized (=0) and BaseA is incremented by 1 in steps S26 and S27 respectively.

i=8:

When i=8, BaseA=2, BaseB=0, and BaseC=1. Therefore, in steps S18 and S19, Column=3 and Row=2, so that an array of Map(8) of “(3, 2)” is generated in step S22 and then BaseB and Count are incremented by 1 in steps S23 and S24 respectively.

i=9:

When i=9, BaseA=2, BaseB=1, and BaseC=1. Therefore, in steps S18 and S19, Column=4 and Row=2. However, because Column=4 is equal to N (=4), “Column=Column−N” is computed in step S21 to correct Column to “4−4=0.” Therefore, Column=0 and Row=2, so that an array of Map(9) of “(0, 2)” is generated in step S22 and then BaseB and Count are incremented by 1 in steps S23 and S24 respectively

i=10:

When i=10, BaseA=2, BaseB=2, and BaseC=1. Therefore, in steps S18 and S19, Column=5 and Row=2. However, because Column=5 is higher than N (=4), “Column=Column−N” is computed in step S21 to correct Column to “5−4=1.” Therefore, Column=1 and Row=2, so that an array of Map(10) of “(1, 2)” is generated in step S22 and then BaseB and Count are incremented by 1 in steps S23 and S24 respectively.

i=11:

When i=11, BaseA=2, BaseB=3, and BaseC=1. Therefore, in steps S18 and S19, Column=6 and Row=2. However, because Column=6 is higher than N (=4), “Column=Column−N” is computed in step S21 to correct Column to “6−4=2.” Therefore, Column=2 and Row=2, so that an array of Map(11) of “(2, 2)” is generated in step S22 and then BaseB and Count are incremented by 1 in steps S23 and S24 respectively. Because this increment makes BaseB equal to N (=4), BaseB is initialized (=0) and BaseA is incremented by 1 in steps S26 and S27 respectively.

i=12:

When i=12, BaseA=3, BaseB=0, and BaseC=1. At this stage, the value of Count is [(N−1)×N], namely, N=4. Because Count=12, Count is initialized (=0) and BaseC is incremented by 1 in steps S16 and S17 respectively. Therefore, BaseA=3, BaseB=0, and BaseC =2 and, in steps S18 and S19, Column=5 and Row=3. Because Column=5 is higher than N (=4), equation “Column=Column−N” is computed in step S21 to correct Column to “5−4=1.” Therefore, Column=1 and Row=3, so that an array of Map(12) of “(1, 3)” is generated in step S22 and then BaseB and Count are incremented by 1 in steps S23 and S24 respectively.

i=13:

When i=13, BaseA=3, BaseB=1, and BaseC=2. Therefore, in steps S18 and S19, Column=6 and Row=3. However, because Column=6 is higher than N (=4), “Column=Column−N” is computed in step S21 to correct Column to “6−4=2.” Therefore, Column=2 and Row=3, so that an array of Map(13) of “(2, 3)” is generated in step S22 and then BaseB and Count are incremented by 1 in steps S23 and S24 respectively.

i=14:

When i=14, BaseA=3, BaseB=2, and BaseC=2. Therefore, in steps S18 and S19, Column=7 and Row=3. However, because Column=7 is higher than N (=4), “Column=Column−N” is computed in step S21 to correct Column to “7−4=3.” Therefore, Column=3 and Row=3, so that an array of Map(14) of “(3, 3)” is generated in step S22 and then BaseB and Count are incremented by 1 in steps S23 and S24 respectively.

i=15:

When i=15, BaseA=3, BaseB=3, and BaseC=2. Therefore, in steps S18 and S19, Column=8 and Row=3. However, because Column=8 is higher than N (=4), “Column=Column−N” is computed in step S21 to correct Column to “8−4−4=0.” Therefore, Column=0 and Row=3, so that an array of Map(15) of “(0, 3)” is generated in step S22 and then BaseB and Count are incremented by 1 in steps S23 and S24 respectively.

i=16:

When i=16, imax(=15) is exceeded and therefore the decision of step S14 is YES, upon which the this program comes to an end.

As described, according to the above-mentioned program, only specifying imax=15 and N=4 can generate the same number sequence map as shown in FIG. 8. In addition, this generating algorithm remains effective if the values of imax and N are changed to other those shown above. If these values are changed, this program can flexibly change number sequence maps accordingly. Therefore, performing the secondary data block storage control and block reading control by use of an algorithm having the same contents as or a similar concept to this program can implement a data storage control method and a data storage control apparatus which mitigate access concentration on a particular storage unit.

Actual Examples of Data Retrieval:

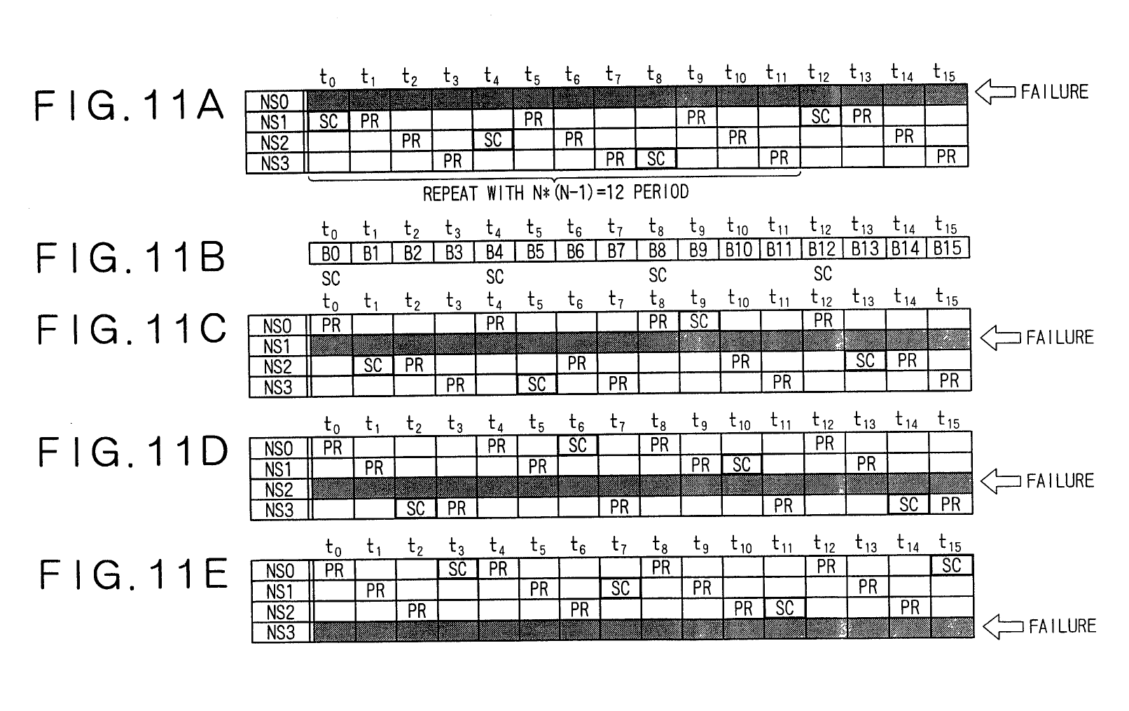

Referring to FIGS. 11A, 11B, 11C, 11D, and 11E, there is shown a schematic diagram illustrating examples of data retrieval to be performed when one (shadowed) of the four storage units 11 through 14 (NS0 through NS3) fails. FIG. 11A illustrates an example in which NS0 failed. FIG. 11C illustrates an example in which NS1 failed. FIG. 11D illustrates an example in which NS2 failed. FIG. 11E illustrates an example in which NS3 failed. In these figures, t0 through t15 are read timings. FIG. 11B illustrates the source data reproduced by synthesizing blocks B0 through B15 read at these timings.

Referring to FIG. 11A in which NS0 failed, when reading B0 at time t0, this block is inaccessible because the primary data of B0 are stored in NS0 (refer to FIG. 7). Therefore, in this case, the storage address (1, 0) of block number i=0 may be obtained by referencing the above-mentioned number sequence map and, by use of the obtained address, block data (B0) stored at Column=1 (therefore, NS1), Row=0 (therefore, the beginning of SC2a) may be read. Subsequently, if the primary data have an inaccessible block, the storage address (Column, Row) of this inaccessible block may be obtained by referencing the above-mentioned number sequence map and the secondary block data having this address may be read as the alternative data. The description of the other blocks will be omitted. It should be noted that “PR” shown in FIG. 11 denotes the block read from the primary data and “SC” denotes the alternative block read from the secondary data.

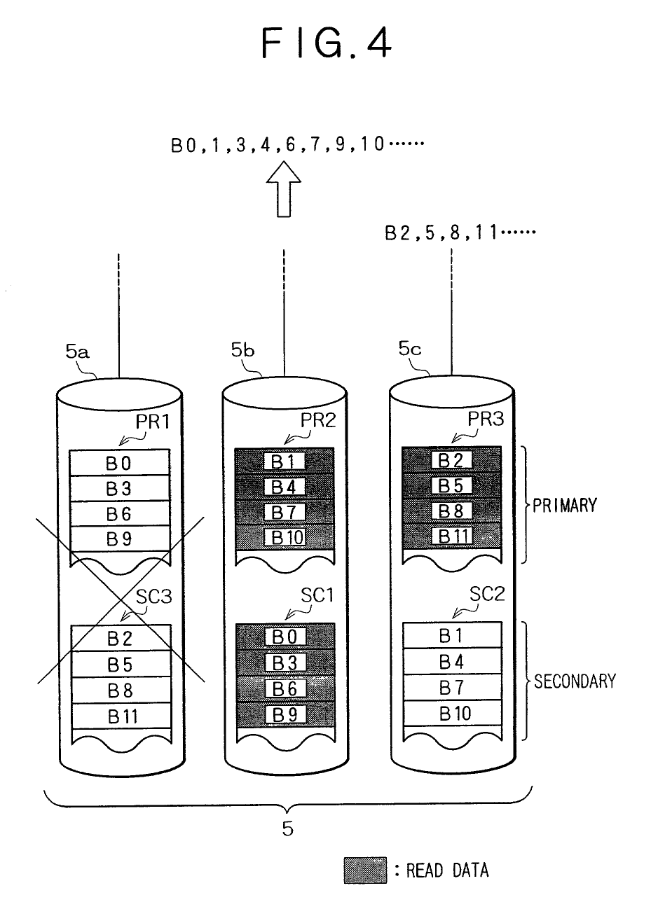

In the fault cases shown in FIGS. 11A, 11C, 11D, and 11E, the locations at which continuous access occurs in the same storage unit are t, t1, t12, t13, t7, and t8 in fault case (a) of NS0. In fault case (c) of NS1, the locations are t1, t2, t8, t9, t13, and t14. In fault case (d) of NS2, the locations are t2, t3, t9, t10, t14, and t15. In fault case (e) of NS3, the locations are t3, t4, t10, and t11. These are the continuous reading of only two blocks and the number of blocks is lower than that in the access concentration in the related art (PR2 and SC1 shown in FIG. 4) and therefore the access concentration in the novel constitution is lighter than that in the related art. Consequently, the present embodiment can achieve of the object of the invention that access concentration on a particular storage unit (one of the storage units 11 through 14) can be mitigated.

As described above, the nature of the present embodiment is the contriving of the control of secondary data block arrangement in order to mitigate the access concentration on a particular one of the storage units (11 through 14) as compared with the related art. The contrivance is that, in changing the arrangement sequence of source blocks, the last one block is turned around to the beginning in the first cyclic period, the last two blocks are turned around to the beginning in the second cyclic period, the last three blocks are turned around to the beginning in the third cyclic period, and so on. The entity for controlling these cyclic periods can be implemented by the driver blocks 15b through 18b in the client machines 15 through 18 respectively as shown in the present embodiment. This implementation may also be performed in various other manners.

For example, a control-dedicated machine having the above-mentioned cyclic periodicity may be connected to the network 19 for use from each of the client machines 15 through 18 or the above-mentioned cyclic control capability may be divided into a plurality of elements to install them on the client machines 15 through 18 or the storage units 11 through 14 in a distributed manner. Alternatively, the above-mentioned control elements may be implemented by both hardware and software in an organizationally connected manner. In this case, the software itself or a storage medium storing this software is included in the present invention as far as this software includes all or part of the features of the present invention.

As described and according to the invention, the correlation between the primary data block array and the secondary data block array stored in a plurality of storage units is lost, thereby mitigating the access concentration to a particular one of the storage units when reading alternative secondary data blocks instead of inaccessible primary data blocks. Consequently, the novel constitution can provide both the high speed operation caused by the distributed storage of block data and the system redundancy due to secondary data storage. Further, the novel constitution provides the data storage control method and apparatus which can mitigate the access concentration on a particular of one storage units if any of them fails.

While the preferred embodiments of the present invention have been described using specific terms, such description is for illustrative purposes only, and it is to be understood that changes and variations may be made without departing from the spirit or scope of the appended claims.

What is claimed is:

1. A data storage control method for dividing source data into a plurality of blocks and storing said plurality of blocks into a plurality of storage units respectively,
said plurality of blocks being composed of a primary data block for normal use and a secondary data block which is read in substitution for said primary data block if the same becomes inaccessible,
said data storage control method comprising the steps of:
when storing said secondary blocks into said plurality of storage units, storing last J blocks in place of first J blocks in every N blocks, N being equal to the number of storage units; and
updating a value of said J sequentially from 1 to N−1 for every N blocks.

2. The data storage control method according to claim 1, wherein said plurality of storage units are random access storage units.

3. The data storage control method according to claim 1, wherein said plurality of storage units are interconnected through a network.

4. A data storage control apparatus for dividing source data into a plurality of blocks and storing said plurality of blocks into a plurality of storage units respectively,
said plurality of blocks being composed of a primary data block for normal use and a secondary data block which is read in substitution for said primary data block if the same becomes inaccessible,
said data storage control apparatus comprising control means for, when storing said secondary blocks into said plurality of storage units, storing last J blocks in place of first J blocks in every N blocks, N being equal to the number of storage units and updating a value of said J sequentially from 1 to N−1 for every N blocks.

5. The data storage control apparatus according to claim 4, wherein said plurality of storage units are random access storage units.

6. The data storage control apparatus according to claim 4, wherein said plurality of storage units are interconnected through a network.

7. A storage medium storing a data storage control program for dividing source data into a plurality of blocks and storing said plurality of blocks into a plurality of storage units respectively,
said plurality of blocks being composed of a primary data block for normal use and a secondary data block which is read in substitution for said primary data block if the same becomes inaccessible,
said data storage control program comprising the steps of:
when storing said secondary blocks into said plurality of storage units, storing last J blocks in place of first J blocks in every N blocks, N being equal to the number of storage units; and
updating a value of said J sequentially from 1 to N−1 for every N blocks.

8. The storage medium according to claim 7, wherein said plurality of storage units are random access storage units.

9. The storage medium according to claim 7, wherein said plurality of storage units are interconnected through a network.
